(19) United States
(12) Patent Application Publication
(10) Pub. No.: US 2005/0217758 A1
(43) Pub. Date: Oct. 6, 2005

(54) Rare earth sintered magnet and method for production thereof

(75) Inventors: Masafumi Fukuzumi, Osaka (JP); Yuji Kaneko, Kyoto (JP)

Correspondence Address: NIXON PEABODY, LLP, 401 9TH STREET, NW, SUITE 900, WASHINGTON, DC, 20004-2128, US

(73) Assignee: NEOMAX CO., LTD, OSAKA (JP)

(21) Appl. No.: 10/507,116

(22) PCT Filed: Jun. 6, 2003
(86) PCT No.: PCT/JP03/07231

§ 371 Date: Sep. 10, 2004

(30) Foreign Application Priority Data
Jun. 13, 2002 (JP) 2002-17330

(51) Int. Cl. H01F 1/057

(52) U.S. Cl. 148/105; 148/302

(57) ABSTRACT

A rare-earth sintered magnet with excellent corrosion resistance and sinterability and a method for producing such a magnet are provided. The rare-earth sintered magnet includes an R₂T₁₄Q type tetragonal compound (where R is at least one rare-earth element, T is at least one transition metal element always including Fe, and Q is boron and/or carbon) as a main phase and a grain boundary phase surrounding the main phase. The R₂T₁₄Q type tetragonal compound as the main phase includes Cr, which substitutes for a portion of Fe, and carbon, which substitutes for a portion of boron, as respective essential elements. The concentration of carbon in the main phase is higher than that of carbon in the grain boundary phase.

### TECHNICAL FIELD

The present invention relates to a rare-earth sintered magnet and a method for producing the same.

### BACKGROUND ART

A rare-earth alloy sintered magnet (permanent magnet) is usually produced by compacting a powder of a rare-earth alloy, sintering the resultant powder compact and then subjecting the sintered compact to an aging treatment. Permanent magnets currently used extensively in various fields of applications include rare-earth-cobalt based magnets and rare-earth-iron-boron based magnets. Among other things, a rare-earth-iron-boron based magnet (which will be referred to herein as an “R—Fe—B based magnet” where R is at least one of the rare-earth elements including Y, Fe is iron and B is boron) is used more and more often in various types of electronic appliances. This is because an R—Fe—B based magnet exhibits a maximum energy product that is higher than any of various other types of magnets and yet is relatively Inexpensive.

An R—Fe—B based sintered magnet includes a main phase consisting essentially of a tetragonal R₂Fe₁₄B compound, an R-rich phase including Nd, for example, and a B-rich phase. An R—Fe—B based sintered magnet is described in U.S. Pat. Nos. 4,770,723 and 4,792,368, for example.

In the prior art, an R—Fe—B based alloy has been prepared as a material for such a magnet by an ingot casting process. In an ingot casting process, normally, rare-earth metal, electrolytic iron and ferroboron alloy as respective start materials are melted by an induction heating process, and then the melt obtained in this manner is cooled relatively slowly in a casting mold, thereby preparing an alloy ingot.

Recently, a rapid quenching process such as a strip casting process or a centrifugal casting process has attracted much attention in the art. In a rapid quenching process, a molten alloy is brought into contact with, and relatively rapidly cooled and solidified by, the outer or inner surface of a single chill roller or a twin chill roller, a rotating chill disk or a rotating cylindrical casting mold, thereby making a rapidly solidified alloy, thinner than an alloy ingot, from the molten alloy. The rapidly solidified alloy prepared in this manner will be referred to herein as an “alloy flake”. The alloy flake produced by such a rapid quenching process normally has a thickness of about 0.03 mm to about 10 mm. According to the rapid quenching process, the molten alloy starts to be solidified from a surface thereof that has been in contact with the surface of the chill roller. That surface of the molten alloy will be referred to herein as a “roller contact surface”. Thus, in the rapid quenching process, columnar crystals grow in the thickness direction from the roller contact surface. As a result, the rapidly solidified alloy, made by a strip casting process or any other rapid quenching process, has a structure including an R₂Fe₁₄B crystalline phase and an R-rich phase. The R₂Fe₁₄B crystalline phase usually has a minor-axis size of about 0.1 μm to about 100 μm and a major-axis size of about 5 μm to about 500 μm. On the other hand, the R-rich phase, which is a non-magnetic phase including a rare-earth element R at a relatively high concentration and which has a thickness (corresponding to the width of the grain boundary) of about 10 μm or less, is dispersed in the grain boundary between the R₂Fe₁₄B crystalline phases.

Compared to an alloy made by the conventional ingot casting process or die casting process (such an alloy will be referred to herein as an “ingot alloy”), the rapidly solidified alloy has been quenched and solidified in a shorter time (i.e., at a quench rate of 10²° C./sec to 10⁴° C./sec). Accordingly, the rapidly solidified alloy has a finer structure and a smaller average crystal grain size. In addition, in the rapidly solidified alloy, the grain boundary thereof has a greater area and the R-rich phase is dispersed broadly and thinly in the grain boundary. Thus, the rapidly solidified alloy also excels in the dispersiveness of the R-rich phase. Because the rapidly solidified alloy has the above-described advantageous features, a magnet with excellent magnetic properties can be made from the rapidly solidified alloy.

An alloy powder to be compacted is obtained by performing the processing steps of: coarsely pulverizing an alloy block, prepared by any of the methods described above, by a hydrogen occlusion process, for example, and/or any of various mechanical milling processes (e.g., using a disk mill); and finely pulverizing the resultant coarse powder (with a mean particle size of 10 μm to 500 μm) by a dry milling process using a jet mill, for example.

The R—Fe—B based alloy powder to be compacted preferably has a mean particle size of 1.5 μm to 6 μm to achieve sufficient magnetic properties. It should be noted that the “mean particle size” of a powder refers herein to a mass median diameter (MMD) unless stated otherwise.

A rare-earth sintered magnet produced by the method described above has bad corrosion resistance and easily gets rusted, which is a serious problem. Thus, to improve the corrosion resistance, a coating film needs to be provided on the surface of the sintered magnet by a plating or evaporation technique. However, the process step of providing such a coating film increases the manufacturing cost adversely. Accordingly, there is an increasing demand for a magnet alloy with improved corrosion resistance.

The applicant of the present application discovered that the corrosion resistance of a rare-earth sintered magnet could be improved by adding Cr to its main phase and disclosed that discovery in Japanese Laid-Open Publication No. 4-268051. However, if Cr were added heavily enough to improve the corrosion resistance sufficiently, then the remanence Br of the magnet would decrease and therefore, the maximum energy product (BH)ₘₐₓ would decrease, too. Also, in the grain boundary of a sintered magnet, the corrosion resistance cannot be increased sufficiently even by adding Cr thereto.

Meanwhile, there is another proposal that the corrosion resistance should be improved by condensing carbon (C) in the grain boundary phase of a sintered magnet such that the main phase is surrounded with the grain boundary phase having a relatively high C concentration (see Japanese Laid-Open Publication No. 4-268051). According to this technique, however, the C added is likely to bond to a rare-earth element R such as Nd in the grain boundary, thus decreasing the sinterability easily.

In order to overcome the problems described above, a primary object of the present invention is to provide a rare-earth sintered magnet with excellent corrosion resistance and sinterability and a method for producing such a magnet.

### DISCLOSURE OF INVENTION

A rare-earth sintered magnet according to the present invention includes an R₂T₁₄Q type tetragonal compound (where R is at least one rare-earth element, T is at least one transition metal element always including Fe, and Q is boron and/or carbon) as a main phase and a grain boundary phase surrounding the main phase. The R₂T₁₄Q type tetragonal compound as the main phase includes Cr, which substitutes for a portion of Fe, and carbon, which substitutes for a portion of boron, as respective essential elements. The concentration of carbon in the main phase is higher than that of carbon in the grain boundary phase.

In one preferred embodiment, 50 at % to 90 at % of the overall grain boundary phase is Co.

In another preferred embodiment, the grain boundary phase includes an R₃CO compound.

In another preferred embodiment, the R₂T₁₄Q type tetragonal compound as the main phase further includes Co as another essential element that substitutes for a portion of Fe.

In another preferred embodiment, the rare-earth sintered magnet includes 12 at % to 18 at % of R, 60 at % to 88 at % of T, 0.1 at % to 2.4 at % of Cr, 0.5 at % to 13 at % of B, and 0.4 at % to 4.5 at % of C.

Another rare-earth sintered magnet according to the present invention includes an R₂T₁₄Q type tetragonal compound (where R is at least one rare-earth element, T is at least one transition metal element always including Fe, and Q is boron and/or carbon) as a main phase and a grain boundary phase surrounding the main phase. The R₂T₁₄Q type tetragonal compound has a natural electrode potential of −0.75 V or more.

In one preferred embodiment, a difference in natural electrode potential between the R₂T₁₄Q type tetragonal compound and the grain boundary phase is at most 0.6 V.

A rare-earth magnet producing method according to the present invention is a method for producing a rare-earth sintered magnet including an R₂T₁₄Q type tetragonal compound (where R is at least one rare-earth element, T is at least one transition metal element always including Fe, and Q is boron and/or carbon) as a main phase and a grain boundary phase surrounding the main phase. The method includes the steps of: preparing a powder of a main phase alloy, at least 50 vol % of which is the R₂T₁₄Q type tetragonal compound and which includes Cr, boron and carbon as respective essential elements, and a powder of a liquid phase alloy including R and Co; and sintering the powders, thereby making a rare-earth sintered magnet in which the concentration of carbon in the main phase is higher than that of carbon in the grain boundary phase.

In one preferred embodiment, the main phase alloy includes 11 at % to 16 at % of R, 60 at % to 87 at % of T, 0.2 at % to 2.5 at % of Cr, 1 at % to 14 at % of B, and 0.5 at % to 5.0 at % of C.

In another preferred embodiment, a first alloy including 0.8 mass % to 1.0 mass % of Q and a second alloy including 1.2 mass % to 1.4 mass % of Q are used as the main phase alloy. The weight ratio of the first and second alloys is preferably defined within the range of 3:1 to 1:3.

In another preferred embodiment, the liquid phase alloy includes 60 at % to 80 at % of R and 20 at % to 40 at % of Co.

In another preferred embodiment, the ratio of the liquid phase alloy to the sum of the main phase and liquid phase alloys is defined within the range of 2 vol % to 20 vol %.

In another preferred embodiment, the method further includes the steps of preparing a melt of a material alloy for the main phase alloy and cooling and solidifying the melt of the material alloy at a rate of 100° C./s to 10,000° C./s.

### BRIEF DESCRIPTION OF DRAWINGS

FIG. 1 shows a configuration for an apparatus for measuring a natural electrode potential (i.e., a potentiostat).

FIG. 2 is a graph showing the polarization curve of an Nd_{11.8}Fe_{82.2}B_{6.0} alloy.

FIG. 3 is a graph showing the polarization curves of Nd_{11.8}Fe_{82.2-x}CoₓB_{6.0} alloys (where x=0, 5, 10, 20 or 50).

FIG. 4 is a graph showing a relationship between the natural electrode potential and the Co substitution percentage for a main phase alloy Nd_{11.8}Fe_{82.2-x}CoₓB_{6.0}, in which a portion of Fe is replaced with Co, and for an intermetallic compound that can be included in the grain boundary phase.

FIG. 5 is a graph showing a relationship between the variation in weight and the natural electrode potential in a corrosion test.

FIG. 6 is a graph showing a relationship between the natural electrode potential and the substitution percentage in a main phase alloy in which Fe is replaced with Co, Ni, Cr and Al.

FIG. 7 is a graph showing relationships between the natural electrode potential and the substitution percentage in a Co-substituted alloy and a Co+C substituted alloy.

FIG. 8 is a graph showing relationships between the natural electrode potential and the substitution percentage in an Ni-substituted alloy and an Ni+C substituted alloy.

FIG. 9 is a graph showing relationships between the natural electrode potential and the substitution percentage in a Cr-substituted alloy and a Cr+C substituted alloy.

FIG. 10 is a graph showing a hydrogen pulverization (or decrepitation) process.

### BEST MODE FOR CARRYING OUT THE INVENTION

A rare-earth sintered magnet according to the present invention includes an R₂T₁₄Q type tetragonal compound (where R is at least one rare-earth element, T is at least one transition metal element always including Fe, and Q is boron and/or carbon) as a main phase and a grain boundary phase surrounding the main phase. In this case, the rare-earth elements include Y (yttrium).

The principal features of the present invention lie in that the R₂T₁₄Q type tetragonal compound as the main phase includes Cr, which substitutes for a portion of Fe, and carbon (C), which substitutes for a portion of boron (B), as respective essential elements and that the C concentration of the main phase is higher than that of the grain boundary phase.

It should be noted that if there is “Cr substituting for a portion of Fe”, then it means that Cr atoms are present at the same type of sites of an R₂T₁₄Q type tetragonal compound crystal as those where Fe atoms are present. Thus, the Fe atoms do not have to be actually replaced with the Cr atoms at particular sites. In the same way, if there is “C substituting for a portion of B”, then it means that Cr atoms are present at the same type of sites of the R₂T₁₄Q type tetragonal compound crystal as those where B atoms are present. Thus, the B atoms do not have to be actually replaced with the C atoms at particular sites.

A sintered magnet according to the present invention, having such a composition, needs the additive Cr in such an amount as to cause no serious deterioration of the magnet performance (e.g., 2 at % or less of the overall magnet). Also, the magnet further includes C as another additive but can improve the corrosion resistance significantly without decreasing its sinterability.

A preferred method of adding Cr and C and setting the concentrations of Cr and C in the main phase higher than those in the grain boundary phase will be described in detail later. First, it will be described in detail based on results of experiments exactly how the R₂T₁₄Q type tetragonal compound can have its corrosion resistance improved by the addition of Cr and C.

### Corrosion Resistance and Natural Electrode Potential

Generally speaking, the corrosion of a metal advances if there is an impurity metal that has such a potential as defining itself as a more precious metal than the former metal is. This is because the impurity metal functions as a local cathode, thus causing a cell reaction more easily. For that reason, to improve the corrosion resistance of a rare-earth magnet, it should be effective to increase the natural electrode potential of the material alloy of the magnet. Meanwhile, it can also be believed that the corrosion of a rare-earth sintered magnet advances through a cell reaction caused by a potential difference between the main phase and grain boundary phase.

However, as to what types of elements should be added how much to improve the corrosion resistance, there were no guidelines allowing for any quantitative estimation. Thus, the present inventors estimated quantitatively the potentials of various types of alloys, making up the main and grain boundary phases, by plotting their polarization curves, thereby analyzing the structure of an anticorrosive (corrosion resistant) rare-earth sintered magnet.

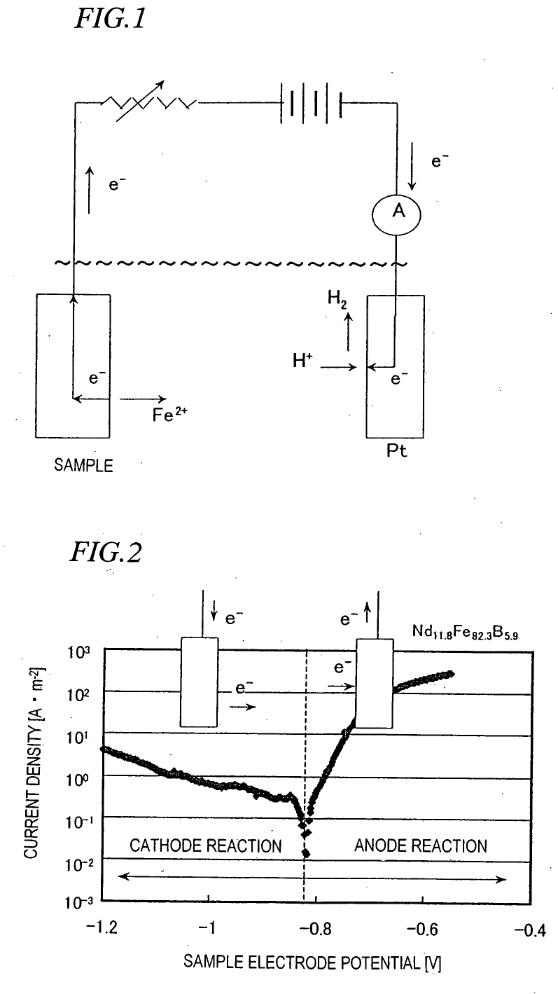

FIG. 1 shows a schematic configuration for a potentiostat apparatus that can be used to measure the natural electrode potentials of various types of metals and alloys. The path of electron (e⁻) when the sample is used as an anode electrode is schematically shown in FIG. 1.

The natural electrode potential of an alloy can be measured by an electrokinetic potential method using the apparatus shown in FIG. 1. More specifically, a sample alloy electrode (Sample) and a reference electrode (or counter electrode) of Pt are immersed in a solution and a voltage applied between these electrodes is changed. As the applied voltage is raised, a portion of the alloy, which makes up the sample alloy electrode, is ionized, thereby emitting electrons within the sample alloy metal electrode. These electrons then travel toward the counter electrode (i.e., the reference electrode of Pt). In the meantime, the number of electrons passing an ammeter is counted as a current density and the counts are plotted with respect to the applied voltage, thereby obtaining a polarization curve.

Each of the natural electrode potentials to be mentioned herein was measured under the following conditions:
The surface area of the sample was set to 1 cm², the polarization potential 2.0 V, the average surface roughness of the sample 0.02 μm or less, and the voltage sweep rate 5 mV/s, respectively.
The reference electrode was made of Hg₂Cl₂ and the counter electrode was a Pt electrode.
To prevent dissolved oxygen from producing a cathode reaction, the dissolved oxygen is eliminated by bubbling the solution with nitrogen for 10 minutes or more before the measurement. During the measurement, a nitrogen gas is allowed to flow on the surface of the solution so as to prevent oxygen in the air from being dissolved in the solution.
2.5% Na₂SO₄ (with a pH of 6.4) was used as the solution, of which the temperature was set to 20° C.

An exemplary polarization curve obtained under the measurement conditions such as these is shown in FIG. 2. Specifically, FIG. 2 shows the polarization curve of an Nd_{11.8}Fe_{82.2}B_{6.0} alloy. In the graph shown in FIG. 2, the ordinate represents the current density between the electrodes of the potentiostat apparatus and the abscissa represents the potential of the sample electrode. As the potential of the sample electrode is going to be raised from a low level to a high level, the current density decreases gradually and the polarization curve has a local minimum value at a certain potential. This particular potential, at which the current density reaches the local minimum value, is called a “natural electrode potential (or corrosion potential)”. While that natural electrode potential is being applied, the cell reaction shown in FIG. 1 keeps an equilibrium state.

The higher the natural electrode potential of an alloy is, the less easily its cell reaction advances. If the potential is raised beyond the natural electrode potential, then the current density starts to increase again. The reason is as follows. While the potential is lower than the natural electrode potential, a cathode reaction advances at the sample electrode. However, once the potential exceeds the natural electrode potential, an anode reaction advances at the sample electrode.

It has been known for a long time that the corrosion resistance of an R—Fe—B based rare-earth sintered magnet can be improved by adding Co to the material alloy of the magnet. However, nobody has ever succeeded in clarifying its reasons fully.

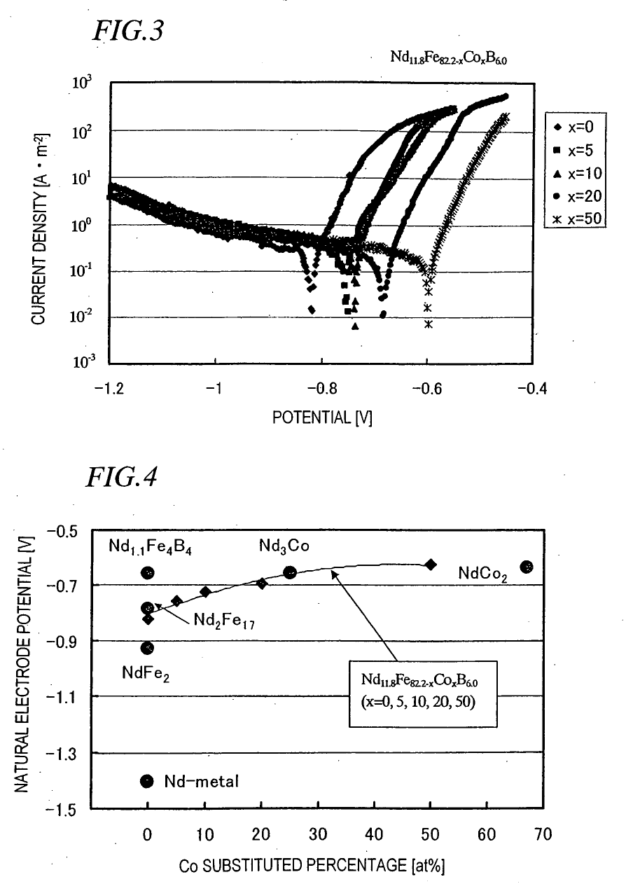

By actually plotting the polarization curve of an Nd—Fe—B based rare-earth magnet alloy to which Co was added, the present inventors confirmed that the addition of Co increased the natural electrode potential. FIG. 3 shows the polarization curve of an Nd_{11.8}Fe_{82.2-x}CoₓB_{6.0} alloy (where x=0, 5, 10, 20 or 50) obtained by substituting Co for a portion of Fe in an Nd_{11.8}Fe_{82.2}B_{6.0} alloy. As is clear from FIG. 3, as the percentage (x) of Co substituted increases, the natural electrode potential of the Nd_{11.8}Fe_{82.2-x}CoₓB_{6.0} alloy increases. The reason is believed to be as follows. Specifically, Fe has a standard oxidation-reduction potential of −0.440 V, while Co has a standard oxidation-reduction potential of −0.277 V. Thus, Co would be less likely to produce an electrochemical reaction than Fe does. And the anode reaction itself should be minimized by the Co substitution.

It is believed that when Co is added to the material alloy of a rare-earth sintered magnet, Co should also be present in the grain boundary phase of the rare-earth sintered magnet and various intermetallic compounds should be produced in the grain boundary phase due to bonding of Co with the rare-earth element R. If there was a big difference between the natural electrode potentials of those intermetallic compounds existing in the grain boundary phase and that of the alloy making up the main phase, then the corrosion resistance might deteriorate. This is because a cell reaction would advance even if the main phase alloy had a high natural electrode potential.

FIG. 4 shows the natural electrode potentials of those intermetallic compounds, which should be produced in the grain boundary phase of the sintered magnet to be finally obtained by adding Co to the material alloy, and the natural electrode potential of the main phase alloy in which a portion of Fe is replaced with Co (i.e., Nd_{11.8}Fe_{82.2-x}CoₓB_{6.0}). Based on the results shown in FIG. 4, it is possible to estimate how easily the main phase alloy and grain boundary phase alloy are subject to corrosion.

First, look at the natural electrode potential of the main phase alloy (i.e., Nd_{11.8}Fe_{82.2-x}CoₓB_{6.0}). As can be seen from FIG. 4, in the range where the percentage x of Co substituted is 50 at % or less, as the percentage x of Co substituted increases, the natural electrode potential increases, too.

Next, referring to FIG. 5, shown is the relationship between the variation in weight and the natural electrode potential when the alloy in which Co is substituted for a portion of Fe (i.e., Nd_{11.8}Fe_{82.2-x}CoₓB_{6.0} alloy) is subjected to a high-temperature high-humidity test (e.g., at a temperature of 80° C. and a relative humidity of 90%). As can be seen from FIG. 5, as the natural electrode potential increases, the alloy has a decreased variation in weight. This weight variation indicates the degree of corrosion of the alloy. That is to say, the smaller the weight variation, the smaller the degree of its corrosion would be.

In view of these considerations, it can be seen that as the natural electrode potential of the alloy increases with the Co substitution, the corrosion becomes more and more unlikely to advance.

Next, the relationship between the natural electrode potentials of the intermetallic compounds produced in the grain boundary phase and that of the main phase alloy will be analyzed with reference to FIG. 4 again. As shown in FIG. 5, the metal Nd (Nd-metal) has as low a natural electrode potential as about −1.40 V, whereas Nd_{11.8}Fe_{82.2}B_{6.0} as the main phase has a relatively high natural electrode potential of about −0.82 V. Accordingly, simply supposing the main phase alloy is Nd_{11.8}Fe_{82.2}B_{6.0} and the grain boundary phase alloy is the metal Nd, the difference in natural electrode potential between them is so large as about 0.7 V that corrosion is easily caused by the cell reaction. However, if about 30 at % of Co is added to the material alloy, then the main phase alloy becomes Nd_{11.8}Fe_{82.2-x}CoₓB_{6.0} and the grain boundary phase alloy contains a lot of Nd₃Co (with a natural electrode potential of −0.66 V). In that case, the potential difference between the main and grain boundary phases is so small that corrosion resulting from the cell reaction hardly occurs between them.

As described above, when Co is added, a portion of Fe in the main phase is replaced with Co to raise the natural electrode potential of the main phase, while an Nd—Co based compound, having a higher natural electrode potential than the metal Nd, is easily produced in the grain boundary phase. Then, there is just a small difference in natural electrode potential between them, and therefore, corrosion due to cell reaction becomes unlikely to occur.

As can be seen from these results, the corrosion can be minimized by setting the natural electrode potential of the main phase alloy high and by reducing the difference in natural electrode potential between the main phase and grain boundary phase alloys.

By appropriately selecting a combination of additive metal elements other than Co in view of these considerations, the present inventors succeeded in obtaining a rare-earth sintered magnet exhibiting an even higher degree of corrosion resistance. More specifically, the present inventors conceived the basic idea of our invention in the discovery that the corrosion resistance of a rare-earth sintered magnet could be increased significantly by making its main phase of an alloy in which Cr, Ni, and/or Al are substituted for a portion of Fe and in which C is substituted for a portion of B. Hereinafter, this point will be described in further detail.

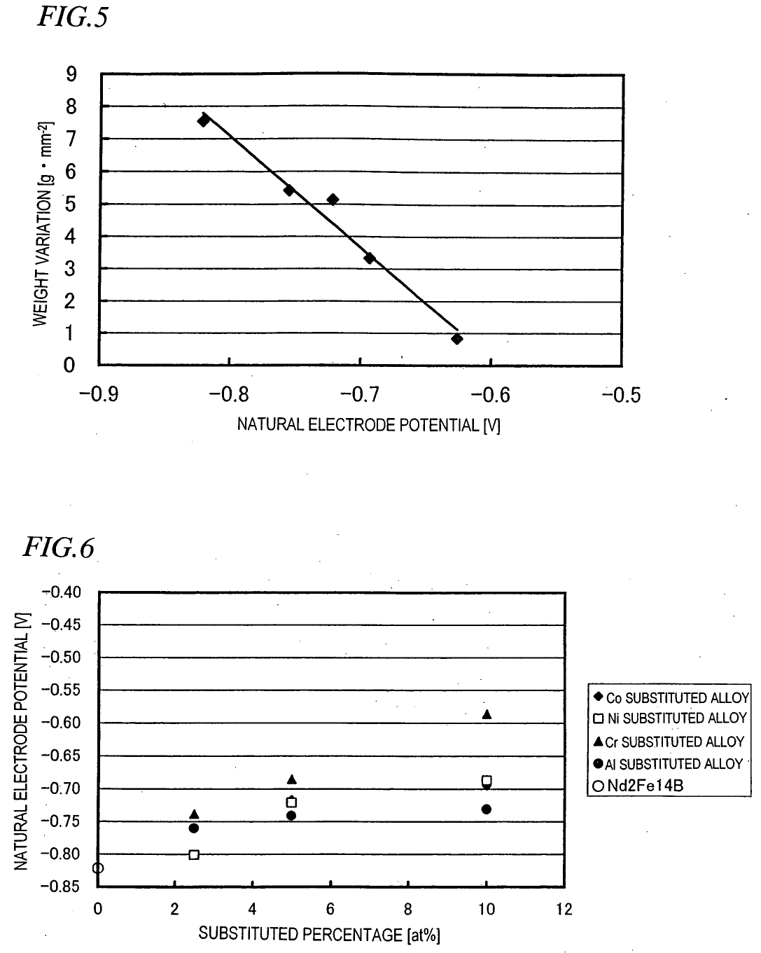

First, an Nd_{11.8}Fe_{82.2-x}MₓB_{6.0} alloy (where M=Co, Ni, Cr or Al) was prepared as a base alloy and the natural electrode potential of the resultant alloy was measured. FIG. 6 shows the relationship between the substituted percentage x and the natural electrode potential. The following can be seen from FIG. 6:
As the substituted percentage x increases, the natural electrode potential increases, too.
Supposing the substituted percentage x is constant, the highest natural electrode potential ever can be obtained when Cr is substituted for a portion of Fe.
Even if Ni is substituted for a portion of Fe, a substituted percentage x of 5 at % or more can result in a natural electrode potential comparable to that obtained by substituting Co for a portion of Fe.

Next, it will be described how the natural electrode potential can be further increased by substituting not only an additive element such as Co for a portion of Fe but also C for a portion of B.

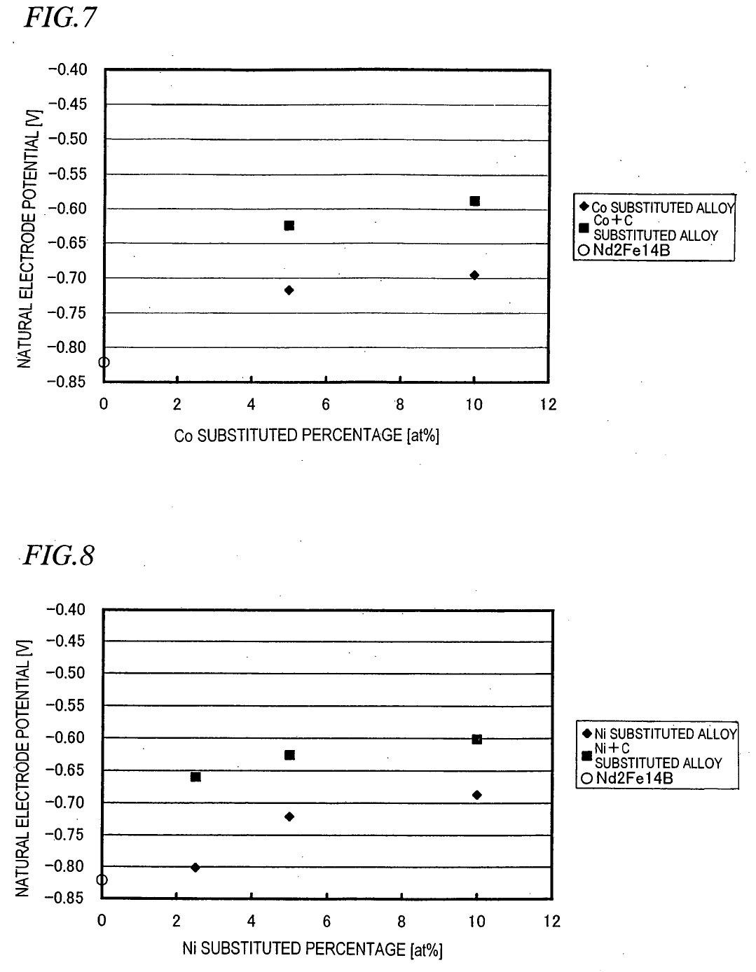

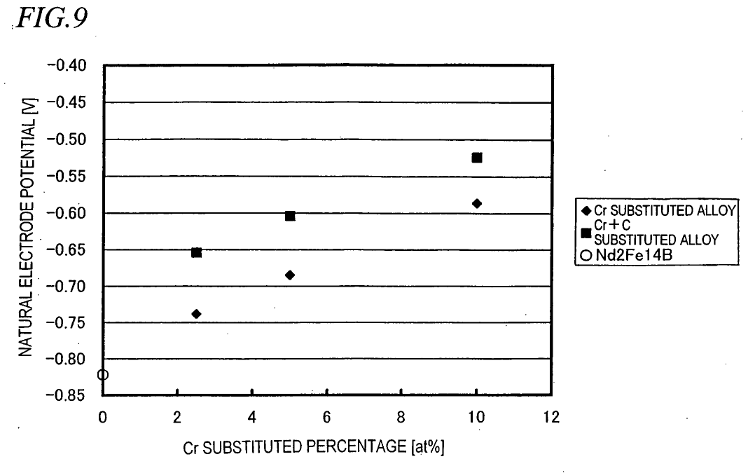

FIGS. 7, 8 and 9 show the natural electrode potentials of an Nd_{11.8}Fe_{82.2-x}MₓB_{6.0} alloy in which Co, Ni or Cr is substituted for a portion of Fe (i.e., M=Co, Ni, Cr or Al) and the natural electrode potentials of an Nd_{11.8}Fe_{82.2-x}MₓB_{6.0-y}C_{y} alloy in which C is also substituted for a portion of B in addition to the former substitution (i.e., M=Co, Ni, Cr or Al). As can be seen from FIGS. 7 through 9, the substitution of C for B further increases the natural electrode potential significantly in any case. Particularly when Cr and C are added (i.e., the Nd_{11.8}Fe_{82.2-x}CrₓB_{6.0-y}C_{y} alloy), the natural electrode potential becomes the highest.

As described above, if a lot of Cr were added to the material alloy, then the remanence Br of the magnet would decrease, and therefore the maximum energy product (BH)ₘₐₓ would decrease, too. However, if C is substituted for a portion of B in the main phase alloy, then the corrosion resistance can be kept high and yet the amount of Cr added can be reduced. Nevertheless, if the C added were not used effectively to substitute for B in the main phase alloy but present a lot in the grain boundary phase of the sintered magnet, then the rare-earth element, C, impurity and O₂ would bond together in the grain boundary phase to decrease the sinterability as described above. Once the sinterability has decreased, the sintering process needs to be performed at a high temperature for a long time. Then, the crystal grains would have grown too much in the resultant sintered magnet and the magnet performance would deteriorate. Accordingly, the problems of the prior art cannot be solved just by adding C to the material alloy. Thus, according to the present invention, a structure that never decreases the sinterability is realized by introducing C heavily into the main phase, not into the grain boundary phase.

### EMBODIMENTS

Hereinafter, a rare-earth sintered magnet producing method according to a preferred embodiment of the present invention will be described.

### Material Alloy

First, a molten alloy is prepared by melting a main phase material alloy within an argon atmosphere by an induction melting process. The main phase alloy preferably has the composition including:
11 at % to 16 at % of R;
60 at % to 88 at % of T;
0.2 at % to 2.5 at % of Cr;
1 at % to 14 at % of B; and
0.5 at % to 5.0 at % of C.

In this preferred embodiment, to condense Cr and C in the main phase, an alloy obtained by adding Cr and carbon to an alloy, of which the composition is close to the stoichiometry of an Nd₂Fe₁₄B type compound, is used as the main phase alloy.

Next, this molten alloy is maintained at 1350° C. and then rapidly cooled by a single roller method, thereby obtaining alloy flakes with a thickness of about 0.3 mm, for example. The rapid solidification process may be performed at a roller peripheral velocity of about 1 m/s, a cooling rate of 500° C./s and a supercooling temperature of 200° C. The rapidly solidified alloy block obtained in this manner is pulverized into flakes with sizes of 1 mm to 10 mm before subjected to the next hydrogen pulverization process. In this manner, a main phase alloy, including 50 vol % or more of R₂T₁₄Q type tetragonal compound and Cr, B and C as essential elements, can be prepared.

If the concentration of Cr in the main phase alloy (i.e., the mass percentage to the overall main phase alloy) were less than 0.2 at %, then the corrosion resistance could not be improved effectively. Thus, the Cr concentration is preferably at least 0.2 at %. However, if the Cr concentration exceeded 2.5 at %, then the remanence Br of the sintered magnet would decrease. For that reason, the Cr concentration is preferably at most 2.5 at %. Consequently, the Cr concentration is preferably 0.2 at % to 2.5 at %, and more preferably 0.3 at % to 2.0 at %.

Also, if the C concentration (i.e., the mass percentage to the overall main phase alloy) were less than 0.5 at %, then the corrosion resistance could not be improved effectively. Thus, the C concentration is preferably at least 0.5 at %. However, if the C concentration exceeded 4.5 at %, then the remanence Br of the sintered magnet would decrease. For that reason, the C concentration is preferably at most 4.5 at %. Consequently, the C concentration is preferably 0.5 at % to 4.5 at %, and more preferably 1.0 at % to 4.0 at %.

To the main phase alloy having such a composition, not just Cr and C but also 0.1 at % to 10 at % of Co, Ni and/or Al or Cu may be added. Among other things, the addition of Co is preferred because it further improves the corrosion resistance effectively.

The additive C should not bond to the rare-earth element R. However, if the alloy is prepared by a rapid cooling process such as a strip casting process, then the production of the R—C compound can be minimized. More specifically, if the melt of the material alloy having the composition described above is rapidly cooled and solidified at a rate of 100° C./s to 10,000° C./s, then the additive C will not bond to the rare-earth element R easily but substitute for a portion of B efficiently.

It should be noted that the main phase alloy may include multiple alloys with different compositions. For example, the main phase alloy may include a first alloy including 0.8 mass % to 1.0 mass % of Q (i.e., the sum of B and C) and a second alloy including 1.2 mass % to 1.4 mass % of Q (i.e., the sum of B and C). In that case, the process step of mixing the first and second alloys together needs to be carried out. However, that mixing process step may be performed either during the process step of finely pulverizing the main phase alloy or during the process step of coarsely pulverizing it.

By mixing together the first and second alloys including Q in different percentages, an R₂T₁₇ phase produced from the first alloy will bond to excessive B or C resulting from the second alloy, and therefore, the C added is more likely to remain in the main phase. Accordingly, it is possible to prevent an Nd—O—C compound (to be produced when C of the main phase alloy reaches the grain boundary phase) from being produced, thus minimizing deterioration in magnetic properties.

Furthermore, by adding the second alloy with a relatively high Q percentage to the first alloy, the mole fractions of B and C will increase. As a result, the R₂T₁₇ phase will change into an R₂T₁₄B phase, thus improving the magnet performance (e.g., coercivity) effectively.

In this preferred embodiment, not only the main phase alloy described above but also a liquid phase alloy including 60 at % to 80 at % of R and 20 at % to 40 at % of Co are prepared. The liquid phase alloy melts faster than the main phase alloy in the sintering process, thus contributing to advancing the liquid phase sintering. The liquid phase alloy finally makes up the grain boundary phase of the sintered magnet.

The present invention is characterized by condensing Cr and C, in particular, in the main phase while reducing the C concentration in the grain boundary phase to as low a level as possible. This is because if the grain boundary phase had a high C concentration, the sinterability would decrease. For that reason, an alloy to which no C is added intentionally is preferably used as the liquid phase alloy.

Also, according to the present invention, to reduce the difference in natural electrode potential between the main and grain boundary phases, an R—Co alloy, including a rare-earth element R and Co as its main ingredients, is used as the liquid phase alloy. Then, an intermetallic compound having a natural electrode potential of −0.70 V or more can be easily produced in the grain boundary phase of the resultant sintered magnet. The grain boundary phase preferably includes R₃CO, while the liquid phase alloy preferably has a composition that produces R₃Co easily. Accordingly, the rare-earth element R in the liquid phase alloy preferably has a concentration of 60 at % to 80 at % and Co preferably has a concentration of 20 at % to 40 at %. More specifically, an alloy including 60 at % of Nd and 40 at % of Co may be used.

R in the liquid phase alloy plays a key role in producing the liquid phase and Co, bonding to the rare-earth element R, contributes to producing a compound of which the natural electrode potential is close to that of the main phase. If the concentration of Co in the liquid phase alloy were less than 20 at %, the natural electrode potential of the resultant grain boundary phase would not become sufficiently high and the difference in natural electrode potential between the main and grain boundary phases would be too big to exhibit the corrosion resistance sufficiently. Nevertheless, if the concentration of Co in the liquid phase alloy exceeded 40 at %, then ferromagnetic RCO₂ would be easily produced in the grain boundary phase of the resultant sintered magnet, thus deteriorating the magnet performance unintentionally.

The liquid phase alloy having the composition described above, as well as the main phase alloy described above, can be prepared by a strip casting process or any other suitable rapid cooling process.

Also, even if other elements such as C, B and Cr were present in the liquid phase alloy in addition to the rare-earth element and Co, there would be no problems as long as their sum is 30 at % or less of the overall liquid phase alloy.

### First Pulverization Process

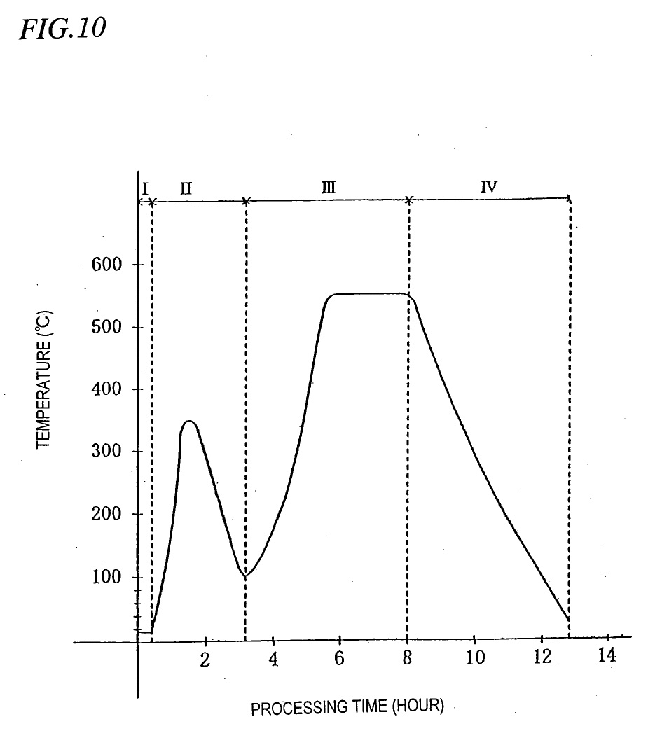

The main phase alloy and liquid phase alloy that have been coarsely pulverized into the flakes are stuffed into a plurality of material packs (made of stainless steel, for example). After the packs have been placed on a rack, the rack with the packs is loaded into a hydrogen furnace. Then, the lid of the hydrogen furnace is closed to start a hydrogen decrepitation process (which will also be referred to herein as a “hydrogen pulverization process”). The hydrogen pulverization process may be performed following the temperature profile shown in FIG. 10, for example. In the example illustrated in FIG. 10, first, an evacuation process step I is carried out for 0.5 hours, followed by a hydrogen occlusion process step II for 2.5 hours. In the hydrogen occlusion process step II, hydrogen gas is supplied into the furnace to create a hydrogen atmosphere inside the furnace. The hydrogen pressure in this process step is preferably about 200 kPa to about 400 kPa.

Subsequently, a dehydrogenation process step III is carried out at a reduced pressure of about 0 Pa to about 3 Pa for 5.0 hours, and then a material alloy cooling process step IV is performed for 5.0 hours with argon gas supplied into the furnace.

To improve the cooling efficiency, the cooling process step IV is preferably performed in the following manner. Specifically, when the temperature of the atmosphere in the furnace is still relatively high (e.g., higher than 100° C.) in the cooling process step IV, an inert gas with an ordinary temperature is supplied into the hydrogen furnace for the cooling purpose. Thereafter, when the material alloy temperature decreases to a comparatively low level (e.g., 100° C. or less), the inert gas that has been cooled to a temperature lower than the ordinary temperature (e.g., a temperature lower than room temperature by about 10° C.) is supplied into the furnace 10. The argon gas may be supplied at a volume flow rate of about 10 Nm³/min to about 100 Nm³/min.

When the temperature of the material alloy has fallen to about 20° C. to about 25° C., an inert gas with a temperature almost equal to the ordinary temperature (i.e., a temperature lower than room temperature by no greater than 5° C.) is preferably supplied into the hydrogen furnace until the temperature of the material alloy reaches the ordinary temperature level. Then, no condensation will be produced inside the furnace when the lid of the hydrogen furnace is opened. If water exists in the furnace due to any condensation, the water will be frozen or vaporized in the evacuation process step. In that case, it is difficult to increase the degree of vacuum and it takes too much time to carry out the evacuation process step I.

When the hydrogen pulverization process is over, the coarsely pulverized alloy powder is preferably unloaded from the hydrogen furnace in an inert atmosphere so as not to be exposed to the air. This prevents oxidation or heat generation of the coarsely pulverized powder and improves the magnetic properties of the resultant magnet. The coarsely pulverized material alloy is then stuffed into a plurality of material packs, which will be placed on a rack.

As a result of this hydrogen pulverization process, each of the main phase alloy and liquid phase alloy is pulverized to sizes of about 0.1 mm to about several millimeters with a mean particle size of 500 μm or less. After the hydrogen pulverization, the decrepitated material alloy is preferably further crushed to finer sizes and cooled with a cooling system such as a rotary cooler. If the material alloy unloaded still has a relatively high temperature, then the alloy should be cooled for a longer time using the rotary cooler or other suitable device.

On the surface of the coarsely pulverized powder obtained by this hydrogen pulverization process, Nd is exposed a lot. Thus, the powder is very easily oxidizable at this point in time.

The coarsely pulverized powders of the main phase and liquid phase alloys may be prepared by subjecting both of these alloys to the hydrogen decrepitation process at the same time as described above. Alternatively, the main phase and liquid phase alloys may be coarsely pulverized separately.

### Second Pulverization Process

Next, the coarsely pulverized powders of the main phase and liquid phase alloys, obtained by the first pulverization process, are mixed together and the mixture is finely pulverized with a jet mill pulverizing machine. A cyclone classifier is connected to the jet mill pulverizing machine for use in this preferred embodiment.

The jet mill pulverizing machine is fed with the rare-earth alloy that has been coarsely pulverized by the first pulverization process (i.e., the coarsely pulverized powder) and gets the powder further pulverized by its pulverizer. The powder, which has been pulverized by the pulverizer, is then collected in a collecting tank by way of the cyclone classifier.

Hereinafter, this process will be described in further detail.

The coarsely pulverized powder that has been fed into the pulverizer is blown up by the high-speed jets of inert gas injected through internal nozzles and swirls together with high-speed gas flows inside the pulverizer. While swirling, the coarsely pulverized powder particles collide against each other so as to be finely pulverized.

The powder particles, which have been finely pulverized in this manner, are guided upward by ascending gas flows to reach a classifying rotor, where the particles are classified so that coarse powder particles are pulverized again. The powder particles that have been pulverized to the predetermined size or less are introduced into the classifier body of the cyclone classifier. In the classifier body, powder particles of relatively large sizes (i.e., equal to or greater than the predetermined particle size) are deposited in the collecting tank located under the classifier body. On the other hand, superfine powder particles are blown up by the inert gas flows and most of them are exhausted out through the exhaust pipe.

In this preferred embodiment, a very small amount of (20,000 ppm or less, e.g., about 10,000 ppm) oxygen is included in the inert gas to be introduced into the jet mill pulverizer. In this manner, the surface of the finely pulverized powder is oxidized moderately so that the finely pulverized powder will not be oxidized too rapidly or generate too much heat when exposed to the air atmosphere. To achieve excellent magnet performance, the concentration of oxygen in the powder is preferably adjusted to the range of 2,000 ppm to 8,000 ppm by weight.

If the concentration of oxygen in the powder exceeded 8,000 ppm, then the rare-earth element would be consumed in producing an oxide in the next sintering process and the amount of rare-earth element contributing to producing the liquid phase would decrease. As a result, the sinterability would decrease or the magnet performance would decline due to the decrease in the percentage of the main phase.

In this preferred embodiment, the mean particle size (i.e., the FSSS particle size) of the powder is set equal to 1.5 μm to 10 μm, more preferably 2 μm to 6 μm (e.g., 3 μm).

Also, considering the preferred volume percentages of the main and grain boundary phases in the resultant sintered magnet, the liquid phase alloy preferably accounts for 2 vol % to 20 vol % of the overall alloy.

### Pressing and Compacting Process

In this preferred embodiment, 0.3 wt % of lubricant is added to, and mixed with, the mixed powder, obtained by the method described above, in a rocking mixer, thereby coating the surface of the alloy powder particles with the lubricant. As the lubricant, a fatty ester diluted with a petroleum solvent may be used. In this preferred embodiment, methyl caproate is used as the fatty ester and isoparaffin is used as the petroleum solvent. Methyl caproate and isoparaffin may be mixed at a weight ratio of 1:9, for example. Such a liquid lubricant not only prevents the oxidation of the powder particles by coating the surface thereof but also improves the degree of alignment of the powder being pressed and the powder compactibility (i.e., increase the uniformity in the density of the compact and eliminate cracking, chipping and other defects).

It should be noted that the lubricant is not limited to the exemplified type. For example, methyl caproate as the fatty ester may be replaced with methyl caprylate, methyl laurylate or methyl laurate. Examples of preferred solvents include petroleum solvents such as isoparaffin and naphthene solvents. The lubricant may be added at any time: before, while or after the fine pulverization process is carried out by the jet mill pulverizer. A solid (dry) lubricant such as zinc stearate may also be used instead of, or in addition to, the liquid lubricant.

Next, the magnetic powder prepared by the method described above is compacted under an aligning magnetic field using a known press machine. The aligning magnetic field to be applied is preferably 0.5 T to 8 T (e.g., 1.1 T). In this manner, a compact with a density of about 3.5 g/cm³ to about 5.0 g/cm³ (e.g., 4.2 g/cm³) is obtained.

### Sintering Process

Next, this compact is sintered. The sintering process may be carried out by keeping the compact heated at 1,080° C. for approximately 4 hours within an argon atmosphere. Instead of performing the sintering process under these conditions, the compact may be kept heated at a temperature of 650° C. to 1,000° C. for approximately 10 to 240 minutes and then further sintered at a higher temperature (e.g., 1,000° C. to 1,100° C.). That is to say, the sintering process may be carried out in two stages. At that temperature of 650° C. to 1,000° C., the liquid phase alloy is melted earlier to produce a liquid phase. Accordingly, by performing this two-stage sintering process, the sintering reaction advances efficiently enough to shorten the high-temperature processing time and minimize the excessive grain growth during the sintering process.

The rare-earth sintered magnet obtained in this manner (with a sintered density of 7.60 g/cm³, for example) includes an R₂T₁₄Q type tetragonal compound as its main phase and a grain boundary phase surrounding the main phase. The R₂T₁₄Q type tetragonal compound as the main phase includes Cr, which substitutes for a portion of Fe, and carbon, which substitutes for a portion of boron, as respective essential elements. Also, the concentration of carbon in the main phase is higher than that of carbon in the grain boundary phase. Accordingly, the natural electrode potential of the main phase increases to −0.75 V or more and the main phase itself has increased corrosion resistance.

In addition, 50 at % to 90 at % of the grain boundary phase of the rare-earth sintered magnet is Co. Among other things, the grain boundary phase includes an R₃CO compound. As a result, the natural electrode potential of the grain boundary phase increases to −0.75 V or more, too, and the difference in natural electrode potential between the main and grain boundary phases can be reduced to at most 0.6 V. Thus, it is possible to prevent corrosion from being produced by a cell reaction between the main and grain boundary phases.

As can be seen, the natural electrode potentials of the main and grain boundary phases are both −0.75 V or more and the difference in natural electrode potential between the main and grain boundary phases is at most 0.6 V. Thus, the corrosion resistance increases so significantly as to realize a sintered magnet that can be used effectively for a long time even without having its surface covered with a coating film. The natural electrode potential of the main phase is preferably at least −0.82 V and more preferably at least −0.8 V.

Furthermore, almost no R—C compound is produced in the grain boundary phase and the alloy can be sintered easily. Accordingly, no crystal grains in the sintered magnet have grown excessively and the production of any compound that would deteriorate the magnet performance is minimized. Consequently, a magnet with excellent magnetic properties (e.g., a remanence Bᵣ of 1.1 T or more and a coercivity iHc of 900 kA/m or more) is realized.

In the preferred embodiment described above, a sintered magnet is produced by a method using two types of alloys with different compositions (i.e., a two-alloy method), and therefore, Cr and C can be concentrated in the main phase efficiently and easily rather than in the grain boundary phase. However, the sintered magnet of the present invention does not have to be formed by this method but may be produced by any other method.

### EXAMPLE

A strip cast alloy A, including 12.35 at % of Nd, 75.92 at % of Fe, 3.20 at % of B, 3.20 at % of C, 2.13 at % of Cr and 3.20 at % of Co, was prepared as the main phase alloy. Meanwhile, another strip cast alloy B, including 60 at % of Nd and 40 at % of Co, was prepared as the liquid phase alloy.

These alloys A and B were mixed together at a volume ratio of 9:1. The mixture was coarsely pulverized by the hydrogen decrepitation process and then finely pulverized with the jet mill, thereby obtaining a finely pulverized powder with a mean particle size of 3.0 μm.

Next, this finely pulverized powder was compressed and compacted under an aligning magnetic field of 1.1 T, thereby obtaining a compact with a green density of 4.0 g/cm³. Then, this compact was sintered at 1,075° C. for four hours within an argon atmosphere. The resultant sintered body had a sintered density of 7.55 g/cm³. In the main phase, a portion of Fe was replaced with Cr, a portion of boron was replaced with C and the C concentration of the main phase was higher than that of the grain boundary phase.

When the magnetic properties of the sintered magnet were measured, its remanence Bᵣ was 1.3 T and coercivity iHc was 1,280 kA/m. Also, even when exposed to a high-temperature high-humidity environment with a temperature of 80° C. and a relative humidity of 90% for 500 hours or more for in an experiment, the sintered magnet hardly got rusted (produced almost no corrosion).

### INDUSTRIAL APPLICABILITY

According to the present invention, Cr and C are introduced into the main phase to raise the natural electrode potential of the main phase alloy and a compound, of which the natural electrode potential is close to that of its main phase, is formed in the grain boundary phase, thereby providing a sintered magnet with excellent sinterability and corrosion resistance. As a result, a rare-earth sintered magnet, which would not corrode even without a surface coating, can be obtained.

1. A rare-earth sintered magnet comprising an R₂T₁₄Q type tetragonal compound (where R is at least one rare-earth element, T is at least one transition metal element always including Fe, and Q is boron and/or carbon) as a main phase and a grain boundary phase surrounding the main phase,
wherein the R₂T₁₄Q type tetragonal compound as the main phase includes Cr, which substitutes for a portion of Fe, and carbon, which substitutes for a portion of boron, as respective essential elements, and
wherein the concentration of carbon in the main phase is higher than that of carbon in the grain boundary phase.

2. The rare-earth sintered magnet of claim 1, wherein 50 at % to 90 at % of the overall grain boundary phase is Co.

3. The rare-earth sintered magnet of claim 2, wherein the grain boundary phase includes an R₃Co compound.

4. The rare-earth sintered magnet of one of claim 1, wherein the R₂T₁₄Q type tetragonal compound as the main phase further includes Co as another essential element that substitutes for a portion of Fe.

5. The rare-earth sintered magnet of claim 1, comprising:
12 at % to 18 at % of R,
60 at % to 88 at % of T,
0.1 at % to 2.4 at % of Cr,
0.5 at % to 13 at % of B, and
0.4 at % to 4.5 at % of C.

6. A rare-earth sintered magnet comprising an R₂T₁₄Q type tetragonal compound (where R is at least one rare-earth element, T is at least one transition metal element always including Fe, and Q is boron and/or carbon) as a main phase and a grain boundary phase surrounding the main phase,
wherein the R₂T₁₄Q type tetragonal compound has a natural electrode potential of −0.75 V or more.

7. The rare-earth sintered magnet of claim 6, wherein a difference in natural electrode potential between the R₂T₁₄Q type tetragonal compound and the grain boundary phase is at most 0.6 V.

8. A method for producing a rare-earth sintered magnet, the magnet including an R₂T₁₄Q type tetragonal compound (where R is at least one rare-earth element, T is at least one transition metal element always including Fe, and Q is boron and/or carbon) as a main phase and a grain boundary phase surrounding the main phase, the method comprising the steps of:
preparing a powder of a main phase alloy, at least 50 vol % of which is the R₂T₁₄Q type tetragonal compound and which includes Cr, boron and carbon as respective essential elements, and a powder of a liquid phase alloy including R and Co; and
sintering the powders, thereby making a rare-earth sintered magnet in which the concentration of carbon in the main phase is higher than that of carbon in the grain boundary phase.

9. The method of claim 8, wherein the main phase alloy includes:
11 at % to 16 at % of R,
60 at % to 87 at % of T,
0.2 at % to 2.5 at % of Cr,
1 at % to 14 at % of B, and
0.5 at % to 5.0 at % of C.

10. The method of claim 9, wherein a first alloy including 0.8 mass % to 1.0 mass % of Q and a second alloy including 1.2 mass % to 1.4 mass % of Q are used as the main phase alloy.

11. The method of claim 9, wherein the liquid phase alloy includes:
60 at % to 80 at % of R and
20 at % to 40 at % of Co.

12. The method of claim 8, wherein the ratio of the liquid phase alloy to the sum of the main phase and liquid phase alloys is defined within the range of 2 vol % to 20 vol %.

13. The method of claim 8, further comprising the steps of:
preparing a melt of a material alloy for the main phase alloy; and
cooling and solidifying the melt of the material alloy at a rate of 100° C./s to 10,000° C./s.
